(19) United States
(12) Patent Application Publication
(10) Pub. No.: US 2006/0153665 A1
(43) Pub. Date: Jul. 13, 2006

(54) Device for splitting book blocks in bookbinding machines

(76) Inventors: Bjorn Hoffmann, Hullhorst (DE); Heiko Landwehr, Barnstorf (DE); Torsten Meineke, Bassum (DE)

Correspondence Address: ALIX YALE & RISTAS LLP, 750 MAIN STREET, SUITE 1400, HARTFORD, CT, 06103, US

(21) Appl. No.: 11/322,978

(22) Filed: Dec. 30, 2005

(30) Foreign Application Priority Data
Jan. 12, 2005 (DE) DE 202005000383.2

(51) Int. Cl. B42C 11/04

(52) U.S. Cl. 412/21

(57) ABSTRACT

A device for centrally splitting book blocks (1) in bookbinding machines, wherein the book blocks (1) being transported forward of a conveyor (2) are split by being pushed against a splitting element (3). In order to also ensure the functionally reliable splitting of book blocks (1) that consist of thick cardboard sheets or panels, a blunt wedge (10) in the form of a gable roof acts upon the front edge cut (1a) of the book block upstream of the splitting element (3) and produces a gap that begins in the leading book block edge and extends into the head edge cut or the foot edge cut (1b) and into the front edge cut (1a). The splitting tool (4) penetrates into the book block (1) through the gap. In one preferred embodiment, a spring-loaded, rotatable wedge roller (10) is used that has a rounded point and a wedge angle (a) of 130°.

### BACKGROUND OF THE INVENTION

The present invention pertains to a device for splitting book blocks in bookbinding machines.

When casing book blocks in a casing-in machine, the book blocks are conventionally transported with the aid of a horizontal conveyor, in a position in which their fore edge cut hangs downward. The book blocks are pushed against a splitting element and subsequently transferred astraddle onto transport plates of the casing-in machine. The desired central splitting of the book blocks is achieved with a splitting element with an upstream splitting point. The splitting point is usually realized in the form of a bottom splitter that opens the book block on its block corner. So-called pointed splinters are used for special products such as, for example, book blocks of lightweight printing paper or blocks for photo albums that consist of cardboard panels with thin separating sheets. These pointed splitters open the book blocks at the foot edge cut or the head edge cut by penetrating into the book block being transported forward with their point. DE 299 20 091 U1 discloses a splitter, in which a separate upstream splitting tool comprises a bottom splitter as well as a pointed splitter. In this case, the bottom splitter or the pointed splitter can be selectively moved into its operative position, in which it is aligned with the splitting element, by turning the tool about a longitudinal axis by 180°.

DE 93 18 238 U1 discloses a splitter that can also be used for splitting book blocks consisting of illustrated panels for children's books or of cardboard panels for photo albums, wherein an air blast nozzle acting upon the fore edge cut of the book block is arranged upstream of the splitting tool in order to fan out the pages of the book blocks. This simplifies the penetration of the splitting tool and prevents damage to the cardboard sheets or panels. The splitting tool contains a splitting point with a blunt or rounded edge that is preferably provided with air blast bores.

If the book block consists of certain thicker sheets, it tends to flutter under the influence of air blasts such that the edges of cardboard sheets or panels are split apart or laminated materials are damaged when they come in contact with the splitting point. Time-consuming corrections in the guidance of the book blocks, as well as adjustments of the intensity and the direction of the air blasts, are required in such instances in order to open the book blocks in a functionally safe fashion.

### SUMMARY OF THE INVENTION

The present invention is based on the objective of developing a device for splitting book blocks in bookbinding machines, which provides the functionally reliable and damage-free splitting of book blocks consisting of thick sheets without requiring significant set-up and adjusting times.

According to the invention, this objective is attained in that a blunt wedge that is realized in the form of a gable roof and acts upon the fore edge cut of the book block is arranged upstream of the splitting element and produces a gap that begins in the leading block edge and extends into the head edge cut or the foot edge cut and into the fore edge cut, whereby a splitting tool of the splitting element subsequently penetrates into the book block through the gap. A slight depth of penetration of the wedge suffices for producing a sufficiently wide gap between the thick cardboard sheets or panels. The splitting tool penetrates into the book block through this defined opening without damaging the sheets.

### BRIEF DESCRIPTION OF THE DRAWING

One embodiment of the invention is described in greater detail below with reference to the figures, wherein

FIG. 1 is a side view of a splitter with a wedge-shaped pressing roller, and

FIG. 2 is a section through the splitter along the line of section II-II in FIG. 1.

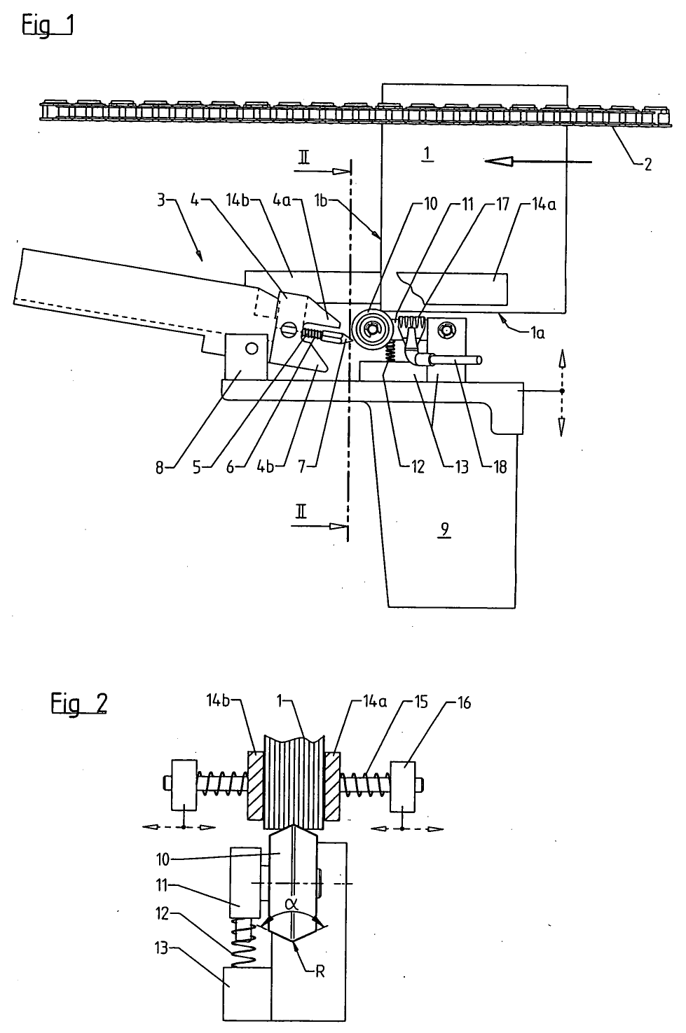

### DESCRIPTION OF THE PREFERRED EMBODIMENT

Book blocks 1 are transported by a conveyor 2 with their spine pointing upward, and pushed against a splitting element 3 in the direction indicated by the arrow in a cyclic fashion such that they are centrally split apart and can be subsequently transferred astraddle to transport plates of a casing-in machine, in which the respective book blocks are joined with a case. A separate splitting tool 4 is arranged upstream of the splitting element 3 on a shaft 5 of the splitting element 3 and comprises an integral bottom splitter 4a for opening the book blocks 1 on the book block edge and an integral pointed splitter 4b for opening the book blocks 1 on the head edge cut or the foot edge cut 1b (depending on conveying orientation). The bottom splitter 4a and the pointed splitter 4b are arranged on the splitting tool 4 diametrically opposite of one another and can be selectively moved into their respective operative position by turning the splitting tool 4 about the longitudinal axis of the shaft 5 by 180°. This is achieved by disengaging the splitting tool 4 from the splitting element 3 by axially displacing the splitting tool on the shaft 5 against the force of a pressure spring 6. In this case, the pressure spring 6 is braced on a stop in the form of an upstream point 7 that is fixed on the free end of the shaft 5. The splitting of the book blocks is promoted by providing the point 7 with an air blast bore that is directed against the front edge cut 1a.

In order to also ensure the functionally reliable splitting of book blocks 1 consisting of thick cardboard sheets or panels, a blunt wedge in the form of a gable roof is arranged upstream of the splitting tool 4 and acts upon the front edge cut 1a of the respective book blocks. This blunt wedge is realized in the form of a rotatable wedge roller 10 and produces a gap that begins in the leading book block edge and extends into the head edge cut or foot edge cut 1b and into the front edge cut 1a. This leading edge is at the corner between the front edge cut and the head or foot edge cut. The bottom splitter 4a subsequently penetrates into the book block 1 through this gap, namely with its edge that ascends in the conveying direction. The wedge roller 10 is accommodated on a lever 11 that is held in a pivoted fashion on a holder 13 and subjected to the force of a pressure spring 12. The holder 13 as well as a block 8 for accommodating the splitting element 3 are mounted on a height-adjustable console 9 in order to adjust a defined depth of penetration of the wedge roller 10 into the book block 1.

The point of the wedge roller 10 has a radius R. The angle between the two smooth, inclined surfaces of the wedge roller 10 is referred to as the wedge angle α and lies between 100° and 150°, preferably at 130°. Guide rails 14a, b for the part of the book block 1 hanging from the conveyor 2 are provided along the conveying direction and yield outward during the splitting of the book blocks 1. The guide rails 14a, b are supported on holders 16 that are adjustable with respect to the thickness of the book block via pressure springs 15 for this purpose. An air blast nozzle 17 that is connected to an air source via a supply line 18 is arranged upstream of the wedge roller 10 in order to act upon the front edge cut 1a and to separate or fan out the individual cardboard sheets of the book block 1, particularly the two sheets to be separated from one another.

1. A device for centrally splitting book blocks of sheets in a bookbinding machine, wherein each book block has a spine, a front edge cut opposite the spine and opposed foot and head edge cuts and the book blocks are transported forward by a conveyor while oriented with an upstream leading edge, then split by being pushed against a splitting tool of a slitting element, wherein the improvement comprises a blunt wedge in the form of a gable roof located upstream of the splitting element in the conveying path of the book block to produce a gap that begins in said leading edge and extends into the head edge cut or the foot edge cut and into the front edge cut, whereby the splitting tool of the splitting element can subsequently penetrate into the book block through said gap.

2. The device according to claim 1, wherein the wedge has a radiused point.

3. The device according to claim 1, wherein the wedge angle (a) lies between 100° and 150°.

4. The device according to claim 3, wherein the wedge angle (α) is 130°.

5. The device according to claim 1, wherein the angled surfaces of the wedge have a low coefficient of friction relative to paper.

6. The device according to claim 1, wherein the wedge is biased toward the front edge cut.

7. The device according to claim 1, wherein the wedge is height-adjustable with respect to its depth of penetration into the book block.

8. The device according to claim 1, including an outwardly yieldable guide acting upon the lateral surfaces of the book block during the splitting of the book block.

9. The device according to claim 1, wherein the wedge is a pressing roller, having an outside surface with a wedge-shaped contour.

10. The device according to claim 9, wherein the pressing roller is rotatably supported.

11. The device according to claim 1, including an air blast nozzle for fanning out the individual sheets, located upstream of the wedge to act upon the front edge cut of the book block.

12. A device for intercepting and centrally splitting sheets of a book block in a casing-in machine as the book blocks are transported forward along a conveying path, comprising:
a splitting element having a splitting tool; and
a blunt wedge in the form of a gable roof, located upstream of the splitting tool to contact and produce a gap in the sheets, whereby the splitting tool can penetrate into the book block through said gap.

13. The device according to claim 12, wherein the wedge has a radiused point.

14. The device according to claim 12, wherein the wedge angle (α) lies between 100° and 150°.

15. The device according to claim 14, wherein the wedge angle (α) is 130°.

16. The device according to claim 12, wherein the wedge is biased toward the book block.

17. The device according to claim 12, wherein the wedge penetrates the book block to an adjustable depth.

18. The device according to claim 12, including an outwardly yieldable guide acting upon the lateral surfaces of the book block during the splitting of the book block.

19. The device according to claim 16, wherein the wedge is a rotatable pressing roller, having an outside surface with a wedge-shaped contour.

20. The device according to claim 19, wherein
each book block has a spine, a front edge cut opposite the spine and opposed foot and head edge cuts and the book blocks are transported forward by a conveyor while oriented with an upstream leading edge and the front edge cut below the spine; and
the wedge is located in the conveying path for contacting said leading edge to produce a gap that begins in said leading edge and extends into the head edge cut or the foot edge cut and into the front edge cut.
